(19) United States
(12) Patent Application Publication
(10) Pub. No.: US 2026/0152149 A1
(43) Pub. Date: Jun. 4, 2026

(54) SYSTEM AND METHOD FOR REGULATING PRESSURE IN WIPER ARM ON SURFACE

(71) Applicant: HCL Technologies Limited, New Delhi (IN)

(72) Inventor: Raghuraman Ganesan, Chennai (IN)

(21) Appl. No.: 19/095,095

(22) Filed: Mar. 31, 2025

(30) Foreign Application Priority Data
Nov. 29, 2024 (IN) 202411093410

(51) Int. Cl. B60S 1/34; B60S 1/08

(52) U.S. Cl. CPC B60S 1/3411; B60S 1/08

(57) ABSTRACT

A system and method for regulating pressure in a wiper arm on a surface is disclosed. The system may include an actuator assembly coupled to a wiper linkage of the wiper arm. The system may include a controller communicably coupled to the actuator assembly. The controller may be configured to generate an actuation command based on one or more predefined conditions. Further, the actuator assembly, in response to the actuation command, may be configured to manoeuvre the wiper linkage from the surface by a predefined gap.

### TECHNICAL FIELD

This disclosure relates generally to the field of a wiper assembly, more particularly to a system and method for regulating pressure in a wiper arm of the wiper assembly on a surface.

### BACKGROUND

Surfaces such as windshields, solar panels, etc. are required to be cleaned from dirt, dust, rainy water, etc. Windshields may be required to be cleaned to provide clear visibility of a road to an occupant thus ensuring smooth driving operation. Also, solar panels must be cleaned to provide maximum solar radiation influx thus ensuring maximum solar radiation absorption. Therefore, a wiper assembly may be installed on the windshields and the solar panels. The wiper assembly may be utilized for the removal of dust, rainwater, dirt, etc. from the windshield and the solar panel. The cleaning operation may be made possible by a constant pressure exerted on the surfaces by a wiper blade in the wiper arm of the wiper assembly. However, the constant pressure may not be required in scenarios such as dry regions, or semi-arid regions, when the wiper assembly is not operating, etc. As a result, the quality and efficiency of the wiper arm may be degraded due to the degradation of wiper blade in such conditions.

Accordingly, there is a requirement for a solution to regulate the pressure exerted by the wiper arm on the surface to be cleaned, when the surface is in dry regions, or semi-arid regions.

### SUMMARY

In an embodiment, a system for regulating pressure in a wiper arm on a surface is disclosed. The system may include an actuator assembly coupled to a wiper linkage of the wiper arm. The system may further include a controller communicably coupled to the actuator assembly. The controller may be configured to generate an actuation command based on one or more predefined conditions. Further, the actuator assembly, in response to the actuation command, may be configured to manoeuvre the wiper linkage from the surface by a predefined gap.

In another embodiment, a wiper assembly is disclosed. The wiper assembly may include a wiper linkage of a wiper arm mounted on a surface. The wiper assembly may include an actuator assembly coupled to the wiper linkage of the wiper arm. The wiper assembly may further include a controller communicably coupled to the actuator assembly. The controller may be configured to generate an actuation command based on one or more predefined conditions. Further, the actuator assembly, in response to the actuation command, is configured to manoeuvre the wiper linkage from the surface by a predefined gap.

In yet another embodiment, a method for regulating pressure in a wiper arm on a surface is disclosed. The method may include generating, by a controller, an actuation command based on one or more predefined conditions. Further, in response to the actuation command manoeuvring, by an actuator assembly communicably coupled to the controller, a wiper linkage from the surface by a predefined gap.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a pressure-regulating system, in accordance with an embodiment of the present disclosure.

FIG. 2A illustrates a front view of a wiper assembly installed on a surface, in accordance with an embodiment of the present disclosure.

FIG. 2B illustrates a front view of a wiper arm on the surface, in accordance with an embodiment of the present disclosure.

FIG. 3A illustrates a front perspective view of the pressure-regulating system when the wiper arm is in an operational state, in accordance with an embodiment of the present disclosure.

FIG. 3B illustrates a front perspective view of the pressure-regulating system when the wiper arm is in a non-operational state, in accordance with an embodiment of the present disclosure.

FIG. 3C illustrates a front perspective view of the wiper arm manoeuvred by a predefined gap, in accordance with an embodiment of the present disclosure.

FIG. 4 illustrates a flow chart of methodology for regulating pressure in the wiper arm on the surface, in accordance with an embodiment of the present disclosure.

### DETAILED DESCRIPTION

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies, and mechanisms for carrying out the same purposes of the present disclosure. It should also be realized by those skilled in the art that such equivalent constructions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, “comprising of” or any other variations thereof, are intended to cover a non-exclusive inclusions, such that a system or a device that comprises a list of components or steps does not include only those components or steps but may include other components or steps not expressly listed or inherent to such setup or device. In other words, one or more elements in a system or apparatus proceeded by “comprises . . . a” does not, without more constraints, preclude the existence of other elements or additional elements in the system or apparatus.

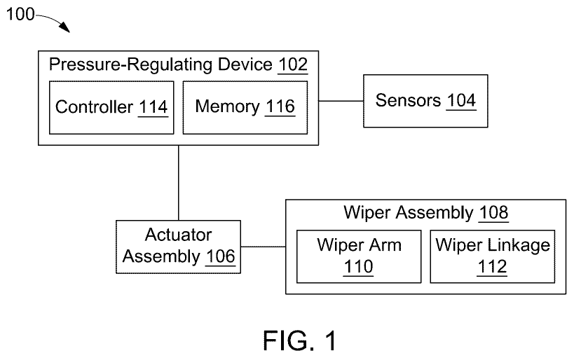

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-4. It is to be noted that the system may be employed in any vehicle including but not limited to a passenger vehicle, a utility vehicle, heavy commercial vehicles, and any other transportable machinery.

Referring to FIG. 1, a block diagram of a pressure-regulating system 100 is illustrated, in accordance with an embodiment of the present disclosure. The pressure-regulating system 100 may be configured to regulate undesired pressure from a wiper assembly on a surface. The surface may include, but not limited to, a windshield of a vehicle, a cover surface of a solar panel, and the like. Examples of the vehicle may include, but not limited to, cars, buses, trucks, aircrafts, locomotives, and the like.

In an embodiment, the pressure-regulating system 100 may include a pressure-regulating device 102, one or more sensors 104, an actuator assembly 106, and a wiper assembly 108. As explained earlier, the pressure-regulating system 100 may regulate undesired pressure of the wiper assembly 108 on the surface. The undesired pressure may lead to a reduction in an efficiency of the wiper assembly 108, i.e. degrading the wiper blade when operated in dry conditions, especially after a prolonged non-operational state. Moreover, the pressure-regulating system 100 may be configured to manoeuvre at least one wiper arm 110 (hereafter referred to as wiper arm 110) of the wiper assembly 108 from the surface by a predefined gap. The predefined gap may include a predefined distance between the wiper arm 110 and the surface. Due to the predefined gap, any contact between the surface and the wiper arm 110 may be eliminated. Accordingly, the pressure on the surface exerted by the wiper arm 110 may be eliminated.

In an embodiment, the pressure-regulating device 102 may be communicatively coupled to the one or more sensors 104 embedded in the vehicle. The one or more sensors 104 may include but not limited to an odometer, a timer, and the like. The one or more sensors 104 may be configured to monitor and transmit sensor value data corresponding to one or more predefined conditions to the pressure-regulating device 102. By way of example, the timer may be configured to monitor timer value data of an elapse of a predefined time interval after initiating a non-operational state of the wiper arm. By way of example, the odometer may be configured to monitor distance value data of a distance traveled by the vehicle when the wiper arm may be in the non-operational state.

In an embodiment, the pressure-regulating device 102 may include a controller 114 and a memory 116. In an embodiment, the controller 114 may include a processor. Alternatively, the controller 114 may be an ECU of the vehicle when the surface may be the windshield, or in some cases, a standalone controller for the pressure-regulating device 102 implemented on the surface of the solar panel. The controller 114 may be coupled to the one or more sensors 104. The controller 114 may receive sensor value data corresponding to the one or more predefined conditions from the one or more sensors 104. For example, the controller 114 may be configured to receive the timer value data of an elapse of a predefined time interval after initiating a non-operational state of the wiper arm 110, and the distance value data of a distance traveled by the vehicle when the wiper arm may be in the non-operational state.

In an embodiment, the memory 116 may store instructions that, when executed by the controller 114, cause the controller 114 to regulate pressure in the wiper arm 110 on the surface based on the one or more predefined conditions. The memory 116 may be a non-volatile memory or a volatile memory. Examples of non-volatile memory may include, but are not limited to a flash memory, a Read Only Memory (ROM), a Programmable ROM (PROM), Erasable PROM (EPROM), and Electrically EPROM (EEPROM) memory. Examples of volatile memory may include but are not limited to Dynamic Random Access Memory (DRAM), and Static Random-Access memory (SRAM). The memory 116 may also store various data of one or more predefined conditions that may be pre-fed and/or required by the system 100 for manoeuvring the wiper arm 110, via the actuator assembly 106.

In an embodiment, the controller 114 may be communicably coupled to the actuator assembly 106 via a communication link. The communication link may be an intra vehicular communication network that may include, but may not be limited to, CAN (Controlled Area Network), CAN FD (Controlled Area Network Flexible Data-Rate), LIN (Local Interconnect Network), local area network (LAN), wide area network (WAN), Ethernet, and the like.

In an embodiment, the actuator assembly 106 may be coupled to the wiper assembly 108. The wiper assembly 108 may include a wiper linkage 112 of the wiper arm 110. By way of example, the wiper assembly 108 may be mounted on the surface to be cleaned. i.e., the windshield of the vehicle and the cover surface of the solar panel. The wiper assembly 108 may include a tensioned spring (not shown) connecting the wiper arm 110 and the wiper linkage under a predefined tension, due to which the wiper arm 110 may exert a pressure on the surface. By way of an example, when the vehicle may include an automobile, the wiper assembly 108 may be adjoined to a base position of the windshield. Further, when the vehicle may include aircraft, train, etc., the wiper assembly 108 may be adjoined to a top position or on the base position of the windshield. By way of example, when the surface is the cover surface of the solar panel, the wiper assembly 108 may be adjoined to any one of the base position, the top position, or at least one predefined side position of the cover surface.

As explained earlier, the actuator assembly 106 may be coupled to the wiper assembly 108. Particularly, the wiper linkage 112 may be coupled to the actuator assembly 106. The actuator assembly 106 may be configured to manoeuvre the wiper linkage 112 based on the one or more predefined conditions.

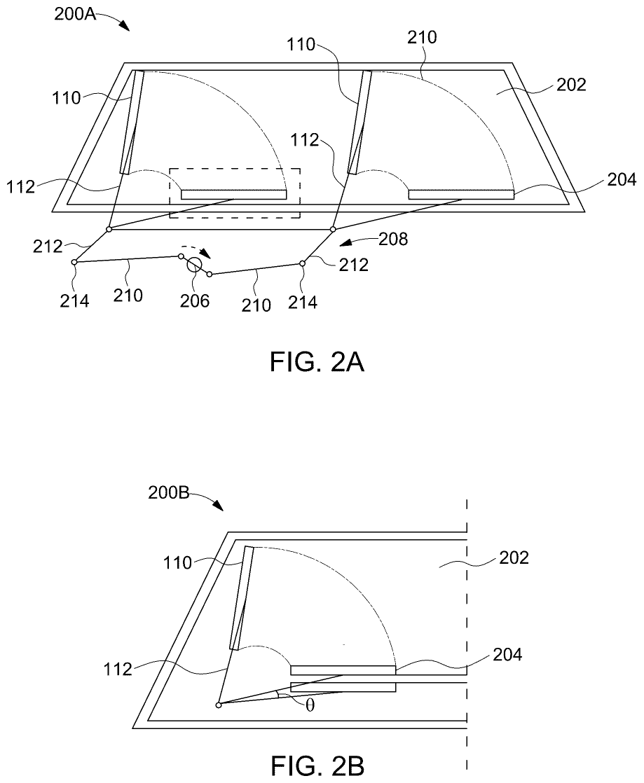

As will be described in greater detail in conjunction with FIGS. 2A-4, in order to regulate the pressure of the wiper arm 110 on the surface, the controller 114 may generate an actuation command based to the actuator assembly 106 based on the one or more predefined conditions. Further, in response to the actuation command, the actuator assembly 106 may manoeuvre the wiper linkage 112 from the surface by the predefined gap. As explained earlier, the one or more predefined conditions may include the elapse of a predefined time interval during a non-operational state of the wiper arm 110. The one or more predefined conditions may further include the distance traveled by the vehicle when the wiper arm 110 may be in the non-operational state.

To further elaborate, consider a scenario when the wiper arm 110 may be in the non-operational state. Further, upon elapse of the predefined time interval during the non-operational state, the controller 114 may generate the actuation command. It is to be noted that, the timer may operate in conjunction with the controller 114 to determine the elapse of the predefined time interval. In response to the actuation command, the controller 114 may actuate the actuator assembly 106 to manoeuvre the wiper linkage 112 from the surface by the predefined gap. The predefined gap formed between the surface and the wiper arm 110 may be of range from about 1 mm- to about 2 mm. It is to be noted that, the predefined gap between the surface and wiper arm 110 may cause the elimination of the pressure developed on the windshield of the vehicle and the cover surface of the solar panel. Further, the assembly of the wiper arm 110 on the surface is explained hereinafter in greater detail in conjunction with FIG. 2A-2B.

In an embodiment, referring to FIG. 2A, which illustrates a front view 200a of the wiper assembly 108 installed on a surface 202, in accordance with an embodiment of the present disclosure. In an embodiment, referring to FIG. 2B, which illustrates a front view 200b of the wiper arm 110 on the surface 202, in accordance with an embodiment of the present disclosure.

In an embodiment, as explained earlier, the wiper assembly 108 may include the wiper linkage 112 of the wiper arm 110 mounted on the surface 202. The wiper linkage 112 may be disposed at a predefined position relative to a base position 204 of the surface 202. By way of example, when the wiper assembly 108 may be installed on the windshield of the vehicle, then the wiper linkage 112 may be disposed below the windshield and a hood of the vehicle. As will be appreciated by the person skilled in the art, due to placement of the wiper assembly 108 on the surface 202, the wiper linkage 112 may remain hidden from the sight of the occupant. Accordingly, the aerodynamics of the vehicle in the transit state remain intact.

In an embodiment, as explained earlier, as the predefined conditions are met, i.e., the distance travelled by the vehicle exceeds a predefined distance threshold and the elapse of the predefined time interval during a non-operational state of the wiper assembly 108, the controller 114 may actuate the actuator assembly 106 to manoeuvre the wiper linkage 112. The manoeuvring of the wiper linkage 112 may be implemented across two stages. In the first stage, the wiper linkage 112 may be rotated to the predefined position relative to the base position 204. Further, the actuator assembly 106 may manoeuvre the wiper linkage 112 from the surface 202 by the predefined gap. This is explained in detail, hereinafter.

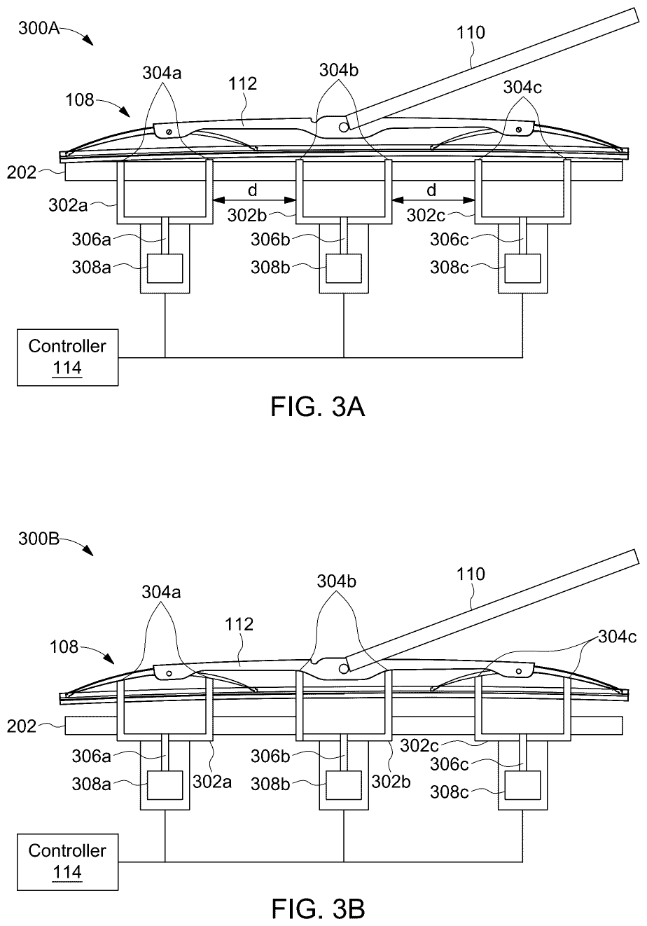

In an embodiment, the wiper linkage 112 may be coupled to a rotary motor 206 via a four-bar mechanism 208. The four-bar mechanism 208 may be operated by the rotary motor 206. The four-bar mechanism 208 may include a pair of input bars 210 and a pair of output bars 212 interconnected by a set of joints 214. The pair of input bars 210 and the pair of output bars 212 may form a closed loop to exhibit a predefined range of motion in order to achieve controlled and predictable oscillatory movement of the wiper arm 110. Further, the pair of input bars 210 may be coupled to the rotary motor 206 and the pair of output bars 212 may be coupled to the wiper linkage 112. The rotary motor 206 may be configured to rotate the pair of input bars 210 within a predefined angle “θ” which may range from about 10° to about 15° relative to the base position 204 of the wiper assembly 108. Accordingly, the rotation of the pair of input bars 210 may result in rotation of the pair of the output bars 212. Thereby, the wiper linkage 112 may be rotated by the rotary motor 206 to the predefined position relative to the base position 204 of the surface 202 by the predefined angle “θ” (As shown in FIG. 2B). After rotation of the wiper linkage 112 to the predefined position, the pressure may be regulated on the surface 202 in the non-operational state of the wiper arm 110. This is explained hereinafter in greater detail in conjunction with FIG. 3A-3C.

In an embodiment, referring to FIG. 3A, which illustrates a front perspective view 300A of the pressure-regulating system 100 when the wiper arm 110 is in an operational state, in accordance with an embodiment of the present disclosure. In an embodiment, referring to FIG. 3B, which illustrates a front perspective view 300B of the pressure-regulating system 100 when the wiper arm 110 is in a non-operational state, in accordance with an embodiment of the present disclosure. In an embodiment, referring to FIG. 3C, which illustrates a front perspective view 300C of the wiper arm 110 maneuvered by the predefined gap, in accordance with an embodiment of the present disclosure. FIGS. 3A-3C are explained in conjunction with FIG. 1 and FIGS. 2A-2B.

As explained in FIG. 1, the pressure-regulating system 100 may include the pressure-regulating device 102, the actuator assembly 106, and the wiper assembly 108. The pressure-regulating device 102 may include the controller 114 and the memory 116. The actuator assembly 106 may include a plurality of connecting rods 302a, 302b, and 302c (hereafter referred to as connecting rods 302) coupled to the wiper linkage 112 at a plurality of predefined locations. The predefined locations may be based on the length and design of the wiper linkage 112. Each location from the plurality of locations may be separated by a predefined distance. The predefined distance “d” may be within a range about, but not limited to, 15-20 mm. Further, each connecting rod 302 may be formed as any one of a C-shaped clamp or a U-shaped clamp, and may include a first end 304a, 304b, and 304c (hereafter referred to as first end 304) respectively. Further, each connecting rod 302 may include a second end 306a, 306b, and 306c (hereafter referred to as second end 306) oppositely disposed to the first end 304.

Further, the wiper linkage 112 may be coupled to the connecting rods 302. The wiper linkage 112 may include at least one extrusion (not shown in figure). The at least one extrusion may be detachably coupled to the first end 304. Accordingly, the at least one extrusion may be detached from the first end 304 when the operational state of the wiper arm 110 is initiated. Similarly, the first end 304 of the C-shaped clamp or the U-shaped clamp may include at least one protrusion formed corresponding to the at least one extrusion.

In an embodiment, the protrusion formed on the first end 304 of the C-shaped clamp or the U-shaped clamp may be accommodated within the at least one extrusion, thus adjoining the wiper linkage 112 with the connecting rods 302. Therefore, the connecting rods 302 may be lifted by the actuator assembly 106 when operated in response to generation of the actuation command.

In an embodiment, the actuator assembly 106 may include a plurality of actuators 308a, 308b, and 308c (hereafter referred to as actuators 308) corresponding to the connecting rods 302. Each actuator 308 may be coupled to the second end 306 of each connecting rod 302. Further, each actuator 308 may be coupled to the controller 114, such that each actuator 308 may be operated based on the actuation command generated by the controller 114.

The actuators 308 may be any one of a pneumatic-based actuator, a hydraulic-based actuator, a spring-based actuator, or an electronic actuator. In an embodiment, the fixed (or stationary) components disclosed above may be retrofitted onto the existing surfaces, i.e., windshields and solar panels by utilizing various techniques known in the art. The assembly of the actuators 308 is explained in hereinafter.

In FIG. 3A, the wiper arm 110 may be in the operational state. The operational state of the wiper arm 110 may be initiated when the vehicle ignition is on and the wiper arm 110 may be utilized by the user for cleaning of the surface 202. The operational state of the wiper arm 110 may include to-and-fro motion thereof on the windshield of the vehicle and the cover surface of the solar panel. Further, upon initiation of the operational state of the wiper arm 110, the at least one extrusion may be detached from the first end 304 in order to allow smooth operation of the wiper arm 110 by allowing to-and-fro motion.

In FIG. 3B, the wiper arm 110 may be in the non-operational state. The non-operational state of the wiper arm 110 may include scenarios when the vehicle ignition is on or off, and the wiper arm 110 may not be operating to clean the windshield and the cover surface. In the non-operational state of the wiper arm 110, the controller 114 may be configured to generate the actuation command based on the one or more predefined conditions explained earlier.

Moreover, upon generation of the actuation command, the controller 114 may actuate the rotary motor 206. The rotary motor 206 may rotate the four-bar mechanism 208 to maneuver the wiper linkage 112 at the predefined angle “θ” from the base position 204. Based on the actuation of the four-bar mechanism 208, the wiper linkage 112 may be rotated to the predefined position relative to the base position 204 at the predefined angle “θ”. The predefined position may be counterclockwise and clockwise from the base position 204. Further, the predefined angle may be, but not limited to, 10°-15° in the counterclockwise or clockwise direction from the base position 204.

After rotation of the wiper linkage 112 to the predefined position relative to the base position 204 at the predefined angle, and upon receipt of the actuation command, the wiper linkage 112 may be maneuvered by the rotary motor 206 to adjoin the C-shaped clamp or the U-shaped clamp from the connecting rods 302.

Referring to FIG. 3C, upon receipt of the actuation command by the controller 114 and the coupling between the wiper linkage 112 and the connecting rods 302, the actuator assembly 106 may lift the connecting rods 302 by the predefined gap “c”. As explained earlier, the predefined gap may be from about 1 mm- to about 2 mm. Consequently, the wiper linkage 112 may be maneuvered from the surface 202 by the predefined gap and may be separated from the surface 202. Hence, due to the separation, the undesired pressure exerted by the wiper arm 110 on the surface 202 may be reduced. Accordingly, degradation of the wiper blade (not shown) in the wiper arm may be prevented.

As explained earlier, the wiper arm 110 may be maneuvered from the windshield by a predefined gap “c”, which may be capable of eliminating any contact of the wiper arm 110 with the surface 202.

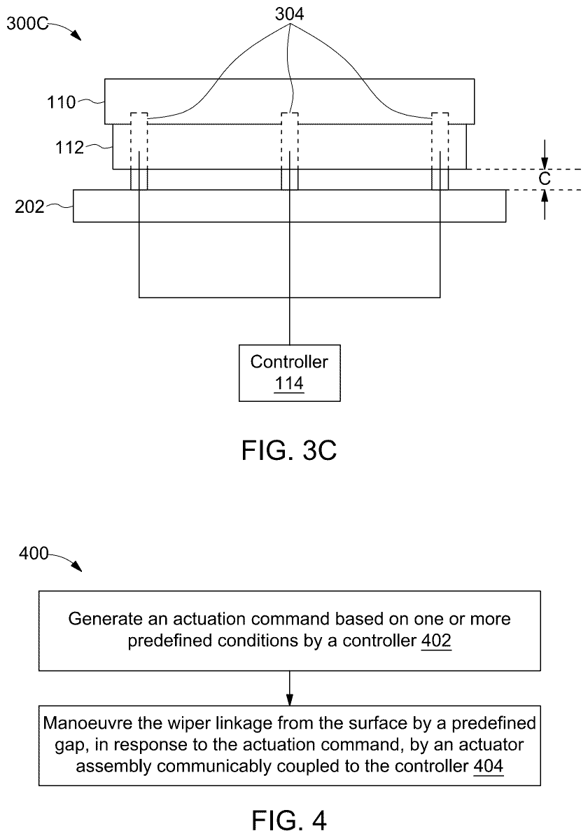

In an embodiment, referring to FIG. 4, which illustrates a flow chart 400 of a methodology for regulating pressure in the wiper arm 110 on the surface 202, in accordance with an embodiment of the present disclosure. It is to be noted that the controller 114 may perform the steps of the flow chart 400. At step 402, the controller 114 may generate an actuation command based on one or more predefined conditions. At step 404, in response to the actuation command, the actuator assembly 106 communicably coupled to the controller 114 may manoeuvre the wiper linkage 112 from the surface 202 by the predefined gap. This is already explained in conjunction with FIGS. 1-3C.

Thus, the disclosed method and system try to overcome the technical problem of undesired pressure exerted by the existing wiper linkage on the windshield of the vehicle and the cover surface of the solar panel by creating a predefined gap therebetween. The predefined gap may be created upon maneuvering of the wiper arm from the surface. The predefined gap eliminates the undesired pressure on the surface, therefore, the life cycle and the quality of the wiper arm may remain intact.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for regulating pressure in a wiper arm on a surface, the system comprising:
an actuator assembly coupled to a wiper linkage of the wiper arm; and
a controller communicably coupled to the actuator assembly, wherein the controller is configured to:
generate an actuation command based on one or more predefined conditions, wherein the actuator assembly, in response to the actuation command, is configured to manoeuvre the wiper linkage from the surface by a predefined gap.

2. The system of claim 1, wherein the actuator assembly comprises:
a plurality of connecting rods coupled to the wiper linkage at a plurality of predefined locations, each connecting rod comprising:
a first end formed as any one of:
a C-shaped clamp, or
a U-shaped clamp;
a second end oppositely disposed to the first end; and
a plurality of actuators corresponding to the plurality of connecting rods, each actuator coupled to the second end of each connecting rod, and each actuator communicably coupled to the controller.

3. The system of claim 2, wherein the wiper linkage comprises:
at least one extrusion,
wherein the at least one extrusion is detachably coupled to the first end upon receipt of the actuation command;
wherein the at least one extrusion is detached from the first end when an operational state of the wiper arm is initiated.

4. The system of claim 2, wherein each actuator is any one of:
a pneumatic-based actuator;
a hydraulic-based actuator;
a spring-based actuator; or
an electronic actuator.

5. The system of claim 1, wherein the surface comprises at least one of:
a windshield of a vehicle; and
a cover surface of a solar panel.

6. The system of claim 1, wherein the one or more predefined conditions comprises:
an elapse of a predefined time interval after initiating a non-operational state of the wiper arm; and
a distance traveled by the vehicle when the wiper arm is in the non-operational state, wherein the distance traveled exceeds a predefined threshold.

7. The system of claim 1, comprising;
a rotary motor coupled to the wiper linkage,
wherein the rotary motor is configured to rotate the wiper linkage to a predefined position relative to a base position of the surface by a predefined angle.

8. A wiper assembly, comprising:
a wiper linkage of a wiper arm mounted on a surface;
an actuator assembly coupled to the wiper linkage of the wiper arm; and
a controller communicably coupled to the actuator assembly, wherein the controller is configured to:
generate an actuation command based on one or more predefined conditions,
wherein the actuator assembly, in response to the actuation command, is configured to manoeuvre the wiper linkage from the surface by a predefined gap.

9. The wiper assembly of claim 8, wherein the actuator assembly comprises:
a plurality of connecting rods coupled to the wiper linkage at a plurality of predefined locations, each connecting rod comprising:
a first end formed as any one of:
a C-shaped clamp, or
a U-shaped clamp; and
a second end oppositely disposed to the first end; and
a plurality of actuators corresponding to the plurality of connecting rods, each actuator coupled to the second end of each connecting rod, and each actuator communicably coupled to the controller.

10. The wiper assembly of claim 9, wherein the wiper linkage comprises:
at least one extrusion,
wherein the at least one extrusion is detachably coupled to the first end upon receipt of the actuation command;
wherein the at least one extrusion is detached from the first end when an operational state of the wiper arm is initiated.

11. The wiper assembly of claim 9, wherein each actuator is any one of:
a pneumatic-based actuator;
a hydraulic-based actuator;
a spring-based actuator; or
an electronic actuator.

12. The wiper assembly of claim 8, wherein the surface comprises at least one of:
a windshield of a vehicle; and
a cover surface of a solar panel.

13. The wiper assembly of claim 8, wherein the one or more predefined conditions comprises:
an elapse of a predefined time interval after initiating a non-operational state of the wiper arm; and
a distance traveled by the vehicle when the wiper arm is in the non-operational state, wherein the distance traveled exceeds a predefined threshold.

14. The wiper assembly of claim 8, comprising:
a rotary motor operatively coupled to the wiper assembly,
wherein the rotary motor is configured to rotate the wiper linkage to a predefined position relative to a base position of the surface by a predefined angle.

15. A method for regulating pressure in a wiper arm on a surface, the method comprising:
generating, by a controller, an actuation command based on one or more predefined conditions; and
in response to the actuation command:
manoeuvring, by an actuator assembly, communicably coupled to the controller, a wiper linkage from the surface by a predefined gap.

16. The method of claim 15, wherein the actuator assembly comprises:
a plurality of connecting rods coupled to the wiper linkage at a plurality of predefined locations, each connecting rod comprising:
a first end formed as any one of:
a C-shaped clamp, or
a U-shaped clamp; and
a second end oppositely disposed to the first end; and
a plurality of actuators corresponding to the plurality of connecting rods, each actuator coupled to the second end of each connecting rod, and each actuator communicably coupled to the controller.

17. The method of claim 16, wherein the wiper linkage comprises:
at least one extrusion,
wherein the at least one extrusion is detachably coupled to the first end upon receipt of the actuation command;
wherein the at least one extrusion is detached from the first end when an operational state of the wiper arm is initiated.

18. The method of claim 16, wherein each actuator is any one of:
a pneumatic-based actuator;
a hydraulic-based actuator;
a spring-based actuator; or
an electronic actuator.

19. The method of claim 15, wherein the surface comprises at least one of:
a windshield of a vehicle; and
a cover surface of a solar panel.

20. The method of claim 15, wherein the one or more predefined conditions comprises:
an elapse of a predefined time interval after initiating a non-operational state of the wiper arm; and
a distance traveled by the vehicle when the wiper arm is in the non-operational state, wherein the distance traveled exceeds a predefined threshold.

21. The method of claim 15, comprising:
a rotary motor coupled to the wiper linkage,
wherein the rotary motor is configured to manoeuvre the wiper linkage at a predefined position relative to a base position of the surface by a predefined angle.
